(19) United States
(12) Patent Application Publication
(10) Pub. No.: US 2023/0232885 A1
(43) Pub. Date: Jul. 27, 2023

(54) METHOD OF FORMING A PRODUCT PIECE AND FORMING TUBE UNIT THEREFOR

(71) Applicant: TVI ENTWICKLUNG UND PRODUKTION GMBH, Bruckmuehl (DE)

(72) Inventor: Markus GEBERT, Eiselfing (DE)

(73) Assignee: TVI ENTWICKLUNG UND PRODUKTION GMBH, Bruckmuehl (DE)

(21) Appl. No.: 18/078,005

(22) Filed: Dec. 8, 2022

(30) Foreign Application Priority Data
Jan. 24, 2022 (DE) 102022101565.3

(51) Int. Cl. A23P 30/10; A23L 13/00; B26D 1/28; A22C 7/00; A22C 17/00

(52) U.S. Cl. CPC A23P 30/10; A22C 7/003; A22C 17/0033; A23L 13/00; B26D 1/28; B26D 2210/02

(57) ABSTRACT

In order to be able to change a cross section of a forming cavity at least with regard to its size, in particular also with regard to its quantitative relations, longitudinal walls circumferentially surrounding the forming cavity are movably fastened relative to a base body in such a way that they can be moved at least in groups synchronously, preferably all longitudinal walls synchronously, relative to a center of the cross section of the forming cavity by means of an actuating element.

### CROSS-REFERENCE TO RELATED APPLICATIONS

This application claims priority to German Patent Application No. DE 102022101565.3 filed on Jan. 24, 2022, the disclosure of which is incorporated in its entirety by reference herein.

### TECHNICAL FIELD

The invention relates to the forming by compression of a product piece which is nearly incompressible due to its high fluid content, consisting of a material which behaves more elastically or more plastically depending on the boundary conditions, such as a piece of grown meat.

Such a product piece, which in its initial state has a varying cross section over its length, is formed into a cross section which is the same over its entire length, and is usually then cut into slices, in particular with a given weight.

### BACKGROUND

For the purposes of the present invention, meat pieces will often be referred to hereinafter without limiting the invention to this particular type of a product piece.

The production of weight-accurate slices or portions from a piece is relatively easy if the piece has the same cross section along its length – then called caliber – and consists of a homogeneous, everywhere the same, limitedly elastic material, such as sausage or cheese, which in addition is usually also somewhat compressible, since it consists to a substantial part of coagulated protein.

For this purpose, so-called slicers are known, which usually cut off one slice at a time with a rotating, round or spiral, blade, which can be moved back and forth, e.g., transversely to the caliber, while the caliber, which is usually exposed, is continuously moved forward.

However, an irregularly shaped product piece of grown meat, e.g., a topside, does not have these properties, because each piece has a different size and form and, moreover, a cross section that changes over the length and consists of material portions of different consistency, elasticity and compressibility, e.g., fat, water, muscle tissue, the surrounding silverskin and possibly also bones as in the case of a cutlet strand, which behave mechanically very differently.

Furthermore, it should be clear that a grown piece of meat is usually an elongated muscle strand, which has a much greater deformability and plasticity in its longitudinal direction, i.e., the direction of its muscle fibers, than transversely, because the lengthening and shortening of the muscle is its causal task.

In this context, it is already known to first reshape such an irregularly shaped product piece so that it has a defined, known cross section over its entire length.

Then a rough relation between the adjustable thickness of the slice and the desired weight of the slice can be established, although not exactly, since from one slice to the next the composition of the meat, whose components have different specific weights, may already change.

In order to achieve this deformation, the product piece – which is usually slightly frozen – is usually first placed in a circumferentially closed forming tube with an internal cavity that remains constant over its length in terms of cross section, and is pressed therein in the longitudinal direction and/or in the transverse direction so that the product piece fills the entire internal space of the forming tube and thus also adopts its cross section, thus forming a uniform product caliber.

For this purpose, the inner cross section of the forming tube lying in the transverse direction can be changed after insertion of the product piece, for example by moving two opposite longitudinal walls of the forming tube towards each other in a first transverse direction to such an extent that transverse compression of the product piece is effected. However, at least one cross section limitation or active transverse pressing is also necessary in a 2. transverse direction, which then requires a transverse press stamp whose width is automatically adjusted or transverse press stamps of different widths, in which case the longitudinal walls may only be adjusted to certain defined distances from one another.

Longitudinal pressing by means of a longitudinal press stamp that can be inserted tightly into the forming tube in the axial direction and presses the product piece against a stop in the longitudinal direction is obligatory in any case.

A slicing machine with a corresponding forming tube is known, for example, from DE 102020134505.4.

### SUMMARY

It is therefore the object of the invention to provide a method and a forming tube unit for forming and pressing the product piece, which avoids the disadvantages described, in particular enabling stepless transverse pressing.

A forming tube unit of the type comprising the forming tube itself, which has a forming cavity of variable cross section open continuously from one end face to the other, the longitudinal direction, in that the longitudinal walls adjoining one another in the circumferential direction and circumferentially surrounding the forming cavity are movable relative to one another in the transverse direction.

Furthermore, the forming tube unit comprises a base body – which can also be part of the forming tube – and an actuating element for moving the longitudinal walls relative to one another.

According to the invention, all longitudinal walls are arranged movably with respect to the base body, and in particular the base body is not part of the forming tube, i.e., does not contain any of the longitudinal walls.

Furthermore, none of the longitudinal walls is adjustable in its cross section measured transversely to the longitudinal direction, but the cross section of the forming cavity is variable in that the longitudinal wall, preferably all longitudinal walls, are each wider than the dimension of the forming cavity in this direction, including its maximum dimension.

This allows the longitudinal walls to have a very simple design.

Preferably, the base body is arranged around the forming tube, in particular a base body ring, in particular a base body circular ring, or a base body sleeve, surrounding the forming tube circumferentially, i.e., around the longitudinal direction, and preferably concentrically, which enables a very simple, largely symmetrical, design of the entire forming tube unit.

The forming tube and its longitudinal walls are designed and connected in such a way that, when the longitudinal walls move relative to one another, the cross-sectional shape of the forming cavity and thus also the longitudinal walls can rotate about its longitudinal centerline.

This provides the greatest possible variability of the forming tube unit. Preferably, two adjacent longitudinal walls in the circumferential direction are guided so as to be displaceable along a wall guide running in a transverse direction, which is preferably designed in such a way that the two guide parts of the two longitudinal walls guided against each other can be moved towards each other only in the running direction of the wall guide but cannot be moved away from each other transversely to the running direction of the wall guide, at least not in the longitudinal region of the wall guide.

Preferably, the wall guide is embodied as a form-fit wall guide, for example in the form of an undercut guide slot as one guide part and a slot nut displaceable therein as the other guide part.

This makes the longitudinal walls highly loadable and enables them to exert considerable pressure on the product piece accommodated in the mold cavity.

The longitudinal walls can move in different ways relative to the base body.

In a first design, the longitudinal walls are pivotally mounted relative to the base body, each about its own first pivot axis extending in the longitudinal direction.

Preferably, if there is an even number of longitudinal walls, every other longitudinal wall is pivotally attached to the base body in this manner.

In addition, each of these pivotable longitudinal walls attached to the base body is additionally pivotably attached to a pivot lever which engages the longitudinal wall at a second pivot axis spaced from the first pivot axis and also extending in longitudinal direction. This pivot lever is used to effect and adjust the extent to which the longitudinal wall pivots relative to the base body.

Each of these pivot levers is pivotally attached at its other end to a common actuating element, again in each case about a base pivot axis extending in longitudinal direction.

By moving this common actuating element relative to the base body, all pivot levers are actuated and all longitudinal walls attached to the pivot levers are pivoted. In this way, a very simple change of the cross section of the forming cavity is possible.

In particular, provided that all longitudinal walls are hinged to one pivot lever each, all first pivot axes must lie on a circle, the first pivot axis circle. In the case of four first pivot axes, however, these four pivot axes should then form a square when viewed in the axial direction, because otherwise a geometric over-determination of the unit would occur.

If each longitudinal wall is connected to the common actuating element via such a second pivot axis and a pivot lever, at least one of the pivot axes of each pivot lever and/or the first pivot axis on the longitudinal wall should have a possibility of movement transverse to its direction of travel, since otherwise a geometric overdetermination also occurs if, for example, in the case of four first pivot axes, these do not form a square when viewed axially.

In any case, all first pivot axes should lie on a first pivot axis circle when viewed axially and/or all second pivot axes should lie on a second pivot axis circle and then, in the case of four first pivot axes, these should at least form a rectangle, or better a square, when viewed axially.

The actuating element for the swivel levers is preferably an actuating ring or actuating sleeve which surrounds the forming tube, in particular concentrically, and can be rotated about its longitudinal center line, in particular the longitudinal center line of the interior of the forming tube cavity, relative to the base body.

Thus, by actuating the common actuating element, all pivot levers are actuated at once.

The control element for actuating the actuating element is preferably a control-driven actuating element such as a working cylinder, whereby the actuating element should be movable in a transverse direction to the longitudinal direction, and in the case of an actuating ring should in particular be movable tangentially to the actuating ring.

In a second design, the longitudinal walls are not pivotable when viewed axially over the base body, but can be moved radially in a linear manner.

For this purpose, at least one longitudinal wall, preferably every second longitudinal wall in the case of an even number of longitudinal walls, must be guided so as to be linearly movable in a transverse direction, in particular radially to the longitudinal center line, relative to the base body.

In this group of longitudinal walls guided linearly relative to the base body, each longitudinal wall is operatively connected to a common actuating element for moving each of these longitudinal walls.

The remaining longitudinal walls are operatively connected to a different actuating element common to this second group.

In this way – at least in the case of an even number of longitudinal walls – the two groups of longitudinal walls can be adjusted individually in the transverse direction, in particular radially, and thus, in the case of four longitudinal walls, for example, not only the size of the cross section but also the relations of the dimensions of the cross section of the forming cavity can be changed.

Hereto, two adjacent longitudinal walls are guided together by a wall guide already described, the longitudinal walls of one of the two groups preferably being constructed in two parts, one longitudinal wall part, the so-called guide part, containing the wall guide, and the other longitudinal wall part, the drive part, being connected to the actuating element.

The guide parts and the drive part are movable relative to each other, in particular pivotable relative to each other or guided together so that they can be moved linearly in a form-fitting manner.

In this way, very individual changes in the cross-section of the forming cavity are possible.

In a slicing machine comprising such a forming tube unit for forming the product piece and, in addition, a cutting unit for cutting the product pieces into slices and a discharge conveyor unit for discharging the cut slices, including a control for controlling moving parts of the slicing machine, the forming tube unit is designed as described above.

With regard to the method for forming an irregularly shaped, in particular elongated, product piece from a partially elastic material by pressing the product piece at least in a cross section into a product caliber which remains constant with regard to the cross section over the length, the method is as follows, that the displacement of the longitudinal walls movable relative to one another is effected in such a way that the longitudinal walls – be it linearly or by a pivoting movement or another movement – approach the longitudinal center, in particular the longitudinal center line, of the forming cavity, but do not lose mutual contact in the process.

This ensures that the forming tube remains circumferentially closed and that no components of the product piece can be pressed out in the circumferential direction.

Preferably, the displacement takes place in such a way that the relations of the cross section of the mold cavity and its basic shape are not changed during the movement of the longitudinal walls, i.e., a rectangular cross section with an aspect ratio of 4:3 retains this aspect ratio and the rectangular shape.

Preferably, in the case of an even number of longitudinal walls of the longitudinal center line of the forming cavity, pairs of longitudinal walls opposite each other, in particular the group of the respective second longitudinal walls, are moved synchronously by means of the actuating element along respective identical movement paths, in particular by means of the common actuating element.

Preferably, all longitudinal walls can also be moved synchronously along identical movement paths in each case, for which, however, a point-symmetrical, in particular square, cross section of the forming cavity is necessary.

In this way, the product piece accommodated in the forming cavity is pressed uniformly in all radial transverse directions, which is particularly gentle on the structure of the product piece.

### BRIEF DESCRIPTION OF THE DRAWINGS

Embodiments according to the invention are described in more detail below by way of example. They show:

FIGS. 1a - c: a known machine for pressing and slicing loaves in side view in partial section in various functional positions,

FIG. 2a: a known embodiment of a forming tube in the side view in section,

FIG. 2b: the forming tube of FIG. 2a in section along the line B - B shown there,

FIG. 2c: the forming tube of FIG. 2a in section cut along the line C - C there,

FIG. 2d: a known multitrack forming tube with variable width

FIGS. 3a, b: a first embodiment of a forming tube according to the invention, viewed in axial direction, in two different functional positions,

FIGS. 4a, b: a second embodiment of a forming tube according to the invention, viewed in the axial direction, in two different operating positions.

### DETAILED DESCRIPTION

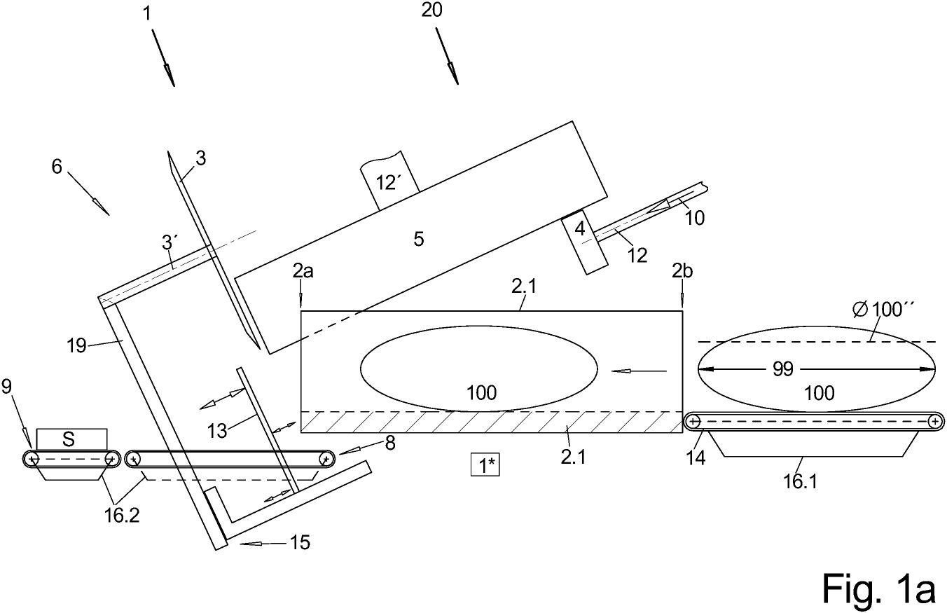

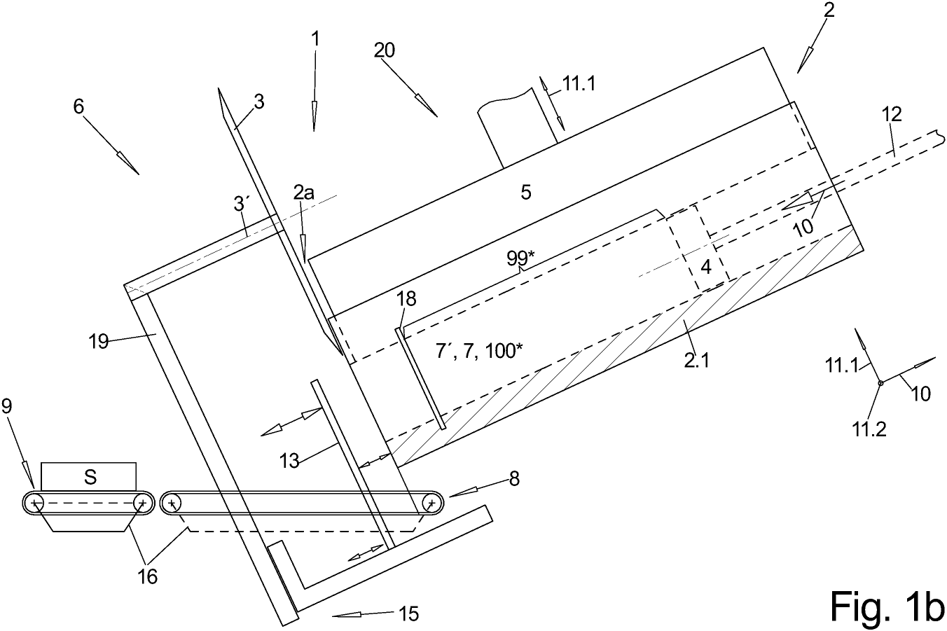

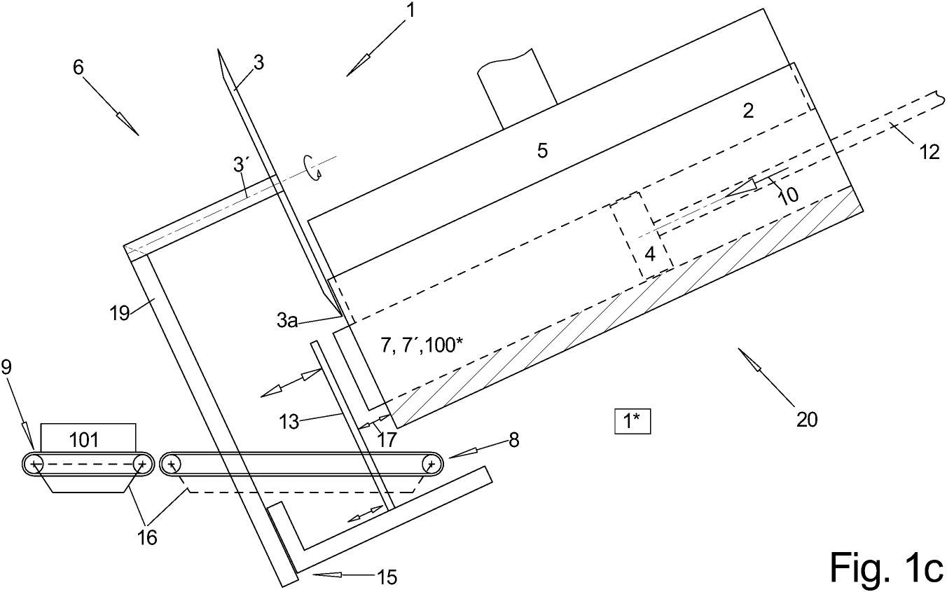

FIGS. 1a, b show – as can best be seen in FIG. 1b – the entire slicing machine 1 which, in addition to the forming tube unit 2 with the forming tube 20 – see FIG. 1b - and the stamps 4, 5, comprises a cutting unit 6 for cutting slices 101 from the pressed product caliber 100*.

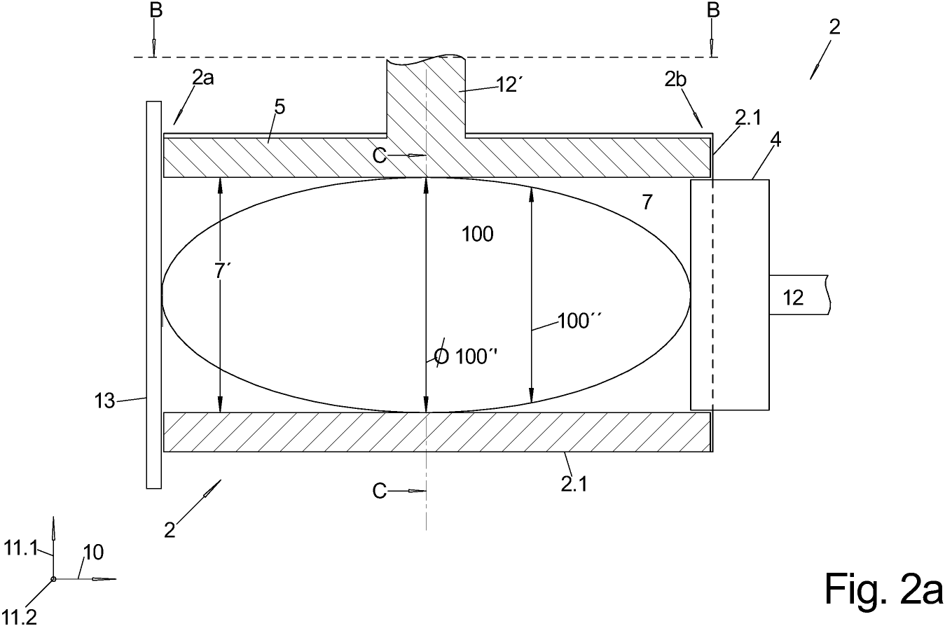

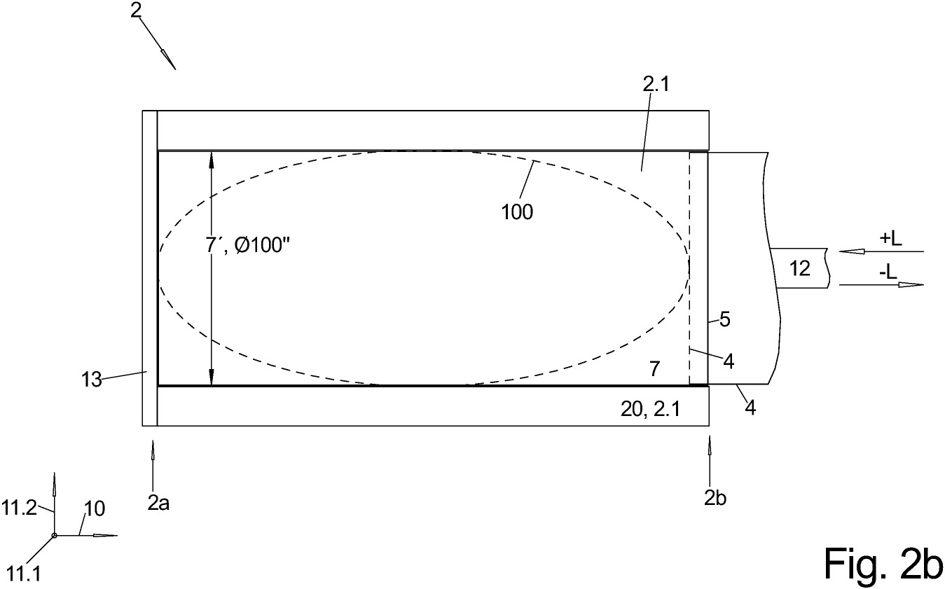

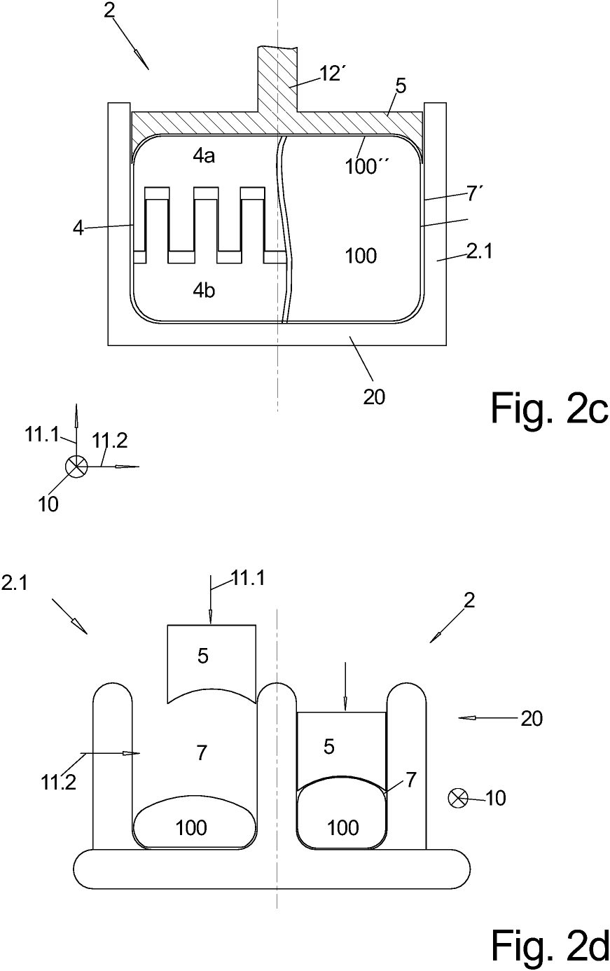

As FIG. 2c shows, the forming tube 20, which is open at the front and back, consists of a forming tube channel 2.1 with a U-shaped cross section, into which a cross press stamp 5 can be inserted from the open side, generally from above, and which together form the forming tube 20.

With regard to the forming tube unit 2, it can further be seen that the forming tube 20 in FIG. 1b is arranged obliquely downwards, and in addition, near the cutting end 2a of the forming tube 20, an intermediate plate 18 can be inserted in the forming tube 20 in such a way that it closes off its entire free cross section 7′ of its internal space, the forming cavity 7. This serves to ensure that when the product piece 100 is pressed, it does not have to be pressed against the stop plate 13 moved up to the forming tube 20, but against the intermediate plate 18 mounted more stably in the forming tube 20 itself.

Since their position in the longitudinal direction 10 is known, the length 99 of the product piece 100 in the longitudinal direction 10 and its cross-sectional area 100″ and the design of the cross-sectional area in the transverse directions 11.1, 11.2, which are at right angles to one another and perpendicular to the longitudinal direction 10, can be deduced from the positions of the cross press stamp 5 and a longitudinal press stamp 4 in their pressing directions 10, 11.1 in the pressed state. The press plungers 4, 5 are attached, for example, to the free end of a piston rod 12 or 12′ which moves them.

As FIG. 1a shows, the forming tube channel 2.1 can be folded down to a horizontal position about a pivot axis extending in the second transverse direction 11.2 in its front region, in this case the lower edge at the cutting end 2a of the forming tube 20, while the cross press stamp 5 and longitudinal press stamp 4 remain in the original position.

In this folded-down position of the forming tube channel 2.1, a new product piece 100 can be moved from the rear end 2b on the loading side to the forming tube channel 2.1 and inserted therein, for example by means of the feed conveyor 14 shown.

At least the beginning and the end of the product piece 100 can be detected by a light barrier, for example, directed from above onto the feed conveyor 14 arranged upstream of the forming tube channel 2.1, from which the length 99 of the product piece 100 in the unpressed state is known on the basis of the speed of the feed conveyor 14.

The weight can be determined by equipping the feed conveyor 14 with a scale 16.1.

From the weight and the length 99, the control 1* can calculate the average cross section (∅́100″) of the unpressed product piece 100.

Subsequently, the forming tube channel 2.1 with the product piece 100 is pivoted upwards again into the pressing position, running parallel to the longitudinal pressing direction 10 of the longitudinal press stamp 4, whereby the cross press stamp 5 and longitudinal press stamp 4 are each in their maximum retracted position, in which they are just immersed in this forming tube channel 2.1, so as not to collide with the unpressed product piece 100 located therein when the forming tube channel 2.1 is pivoted upwards.

FIGS. 2a and 2b show the known forming tube 20 alone in principle representation in a vertical longitudinal section and in top view.

As can be seen in FIG. 2c, the inner surfaces of the side walls of the U-shaped forming tube channel 2.1 run parallel to each other, and in FIG. 2c at a non-variable distance from each other, so that the cross press stamp 5 can have a fixed width in the direction of the width of the opening of the forming tube channel 2.1, the second transverse direction 11.2, and likewise have a fixed length in the longitudinal direction 10, namely, for example, corresponding to the length of the forming tube channel 2.1.

In FIG. 2a, the cross press stamp 5 is moved to such a distance from the bottom of the forming tube channel 2.1 that the free cross section 7′ therebetween still almost corresponds to the largest cross section of the unpressed product piece 100. Consequently, the product piece 100 is already somewhat compressed in the transverse direction 11.1 and has a length which - without pressing force in the longitudinal direction 10 - is somewhat greater than the length 99* in the unpressed state.

Qualitatively, however, the product piece 100 still has, according to its initial state, an approximately elongated egg-shaped form or also the form of an American football, with a cross section 100″ which changes in the longitudinal direction 10 and is still larger in the middle length range than at its ends.

With such an adjustment of the inner free cross section 7′, the product piece 100 is then, as shown in FIG. 1b, first pushed forward against the intermediate plate 18 or, as shown in FIG. 2b, against the stop plate 13 at the front end 2a of the forming tube 20 by means of the longitudinal press stamp 4.

The product piece 100 is then pressed to the product caliber 100* shown in FIG. 1b in the longitudinal direction 10 only by further forward movement of the press rams 4, 5 until the entire forming tube cavity 7 of the forming tube 20 up to the stop 13 or 18 is filled with the material of the product piece 100, which then has a significantly shorter length 99*.

The measurement of the length and the cross section of the product caliber 100* in the compressed state is, however, as described, not carried out with the force, in particular at the longitudinal press stamp 4, which was necessary for the compression, but with a measuring force which is considerably lower.

FIG. 1c shows the subsequent automatic cutting of the pressed product caliber 100* into slices 101 after removal of the intermediate plate 18.

For this purpose - after removal of the intermediate plate 18 - the pressed product caliber 100* is pushed further forward by means of the longitudinal press stamp 4 with a cutting force which preferably corresponds to the measuring force, namely beyond the cutting end 2a of the forming tube 20 by a desired slice thickness, in that the product caliber 100* should rest with its front end face against a stop plate 13 set at a corresponding distance 17 from the forming tube 20.

When in longitudinal direction 10 the position of the product caliber 100* for cutting off the next slice 101 in this way is reached, the cutting edge 3a of a round or sickle-shaped blade 3 rotating in this case about a blade axis 3′ increasingly moves in transverse direction 11.1 into the cross section of the product caliber 100* and cuts off a slice 101.

As the blade 3 moves into, the stop plate 13 is also moved in the same transverse direction so that the separated slice 101 can tip down over the upper edge of the stop plate 13 and fall onto the discharge conveyor 8 located immediately below, which transports it away and transfers it to another discharge conveyor 9.

One of the two discharge conveyors, preferably the downstream discharge conveyor 9, comprises a scale 16 for weighing the individual slice 101 produced, and their weight is fed back to the control 1* of the machine 1 for automatic correction of the thickness of the subsequent slice 101 by changing the distance 17.

FIG. 1c shows the condition in which the product caliber 100* is already partially cut into slices 101.

For this purpose, both the blade 3 and the stop plate 13 are movably mounted on a base frame 15 of the cutting unit 6, along which the stop plate 13 can be adjusted in its distance 17 in longitudinal direction 10, and along which also the blade 3, held on a support arm 19, can be moved at least in one of the transverse directions to the longitudinal direction 10, preferably the first transverse direction 11.1, the transverse pressing direction of the cross press stamp 5.

If the longitudinal press stamp 4 - which is arranged between the cross press stamp 5 and the forming tube channel 2.1 during pressing or advancing - can move in the transverse press direction, the first transverse direction 11.1, the free cross section 7′ between the forming tube channel 2.1 and the cross press stamp 5, it must, for example - as shown in FIG. 2c, left half - consist of two parts 4a, 4b, which have alternating prongs and recesses on the side facing each other, which dip into each other, so that the cross press stamp 5 can thereby change its extension in this transverse direction 11.1, which happens automatically, since the two parts 4a, b are pretensioned by means of springs in the direction pointing away from each other.

FIG. 2d shows how two forming tube channels 2.1 can be present next to each other for cutting two product pieces 100. The middle of three longitudinal walls projecting from a bottom of the forming tube channel 2.1 is firmly connected to the latter, in particular in one piece, while the two outer longitudinal walls can be adjusted in their distance to the latter in the 2nd transverse direction 11.2 from a large distance for insertion of the product piece 100 to a smaller distance for subsequent pressing of the product piece 100, which then also corresponds to the width of the cross press stamp 5 to be inserted from above into the respective forming tube channel 2.1.

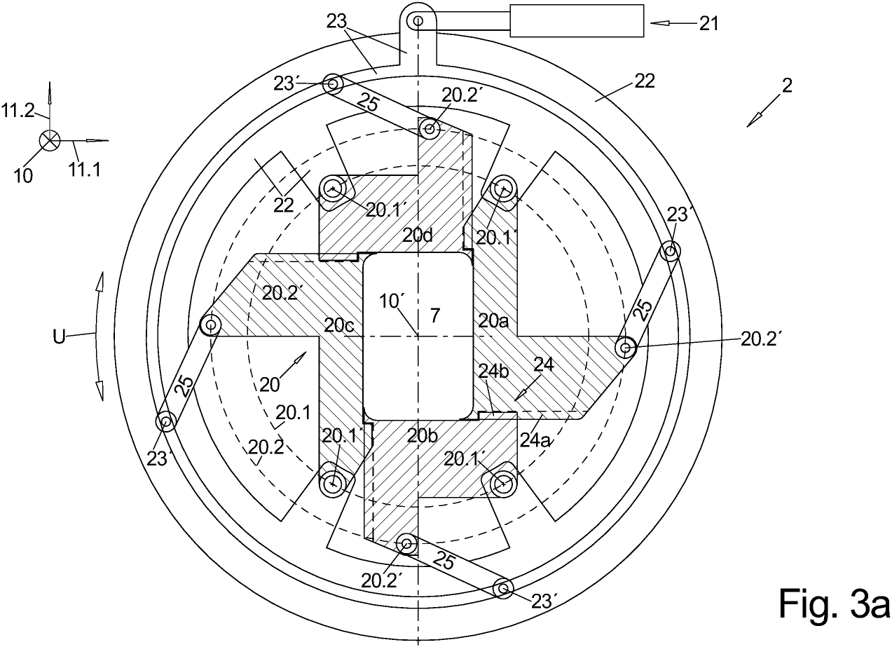

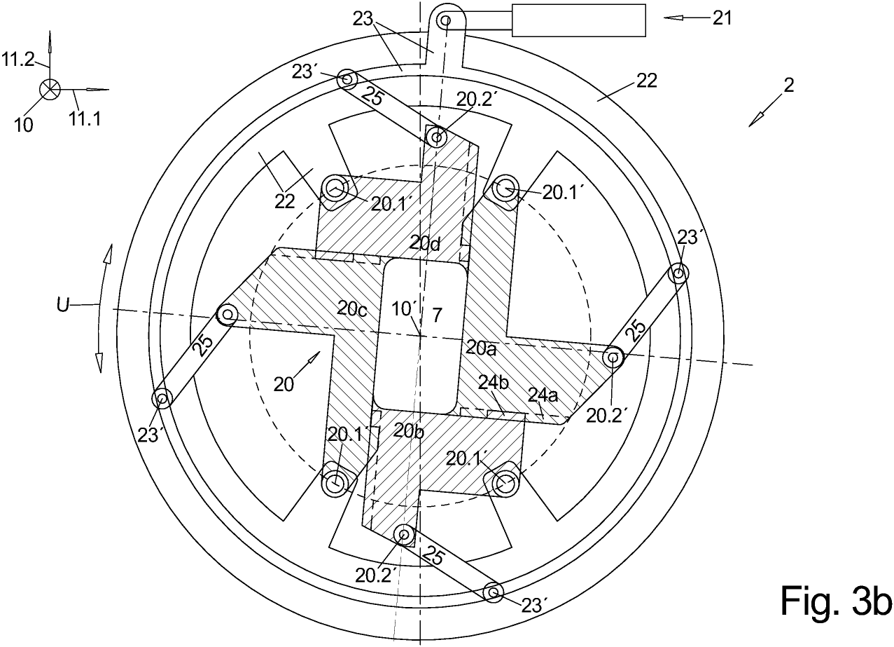

FIGS. 3a, b and 4a, b show two different designs of a forming tube unit 2 according to the invention compared with the known embodiment of FIGS. 2c, d.

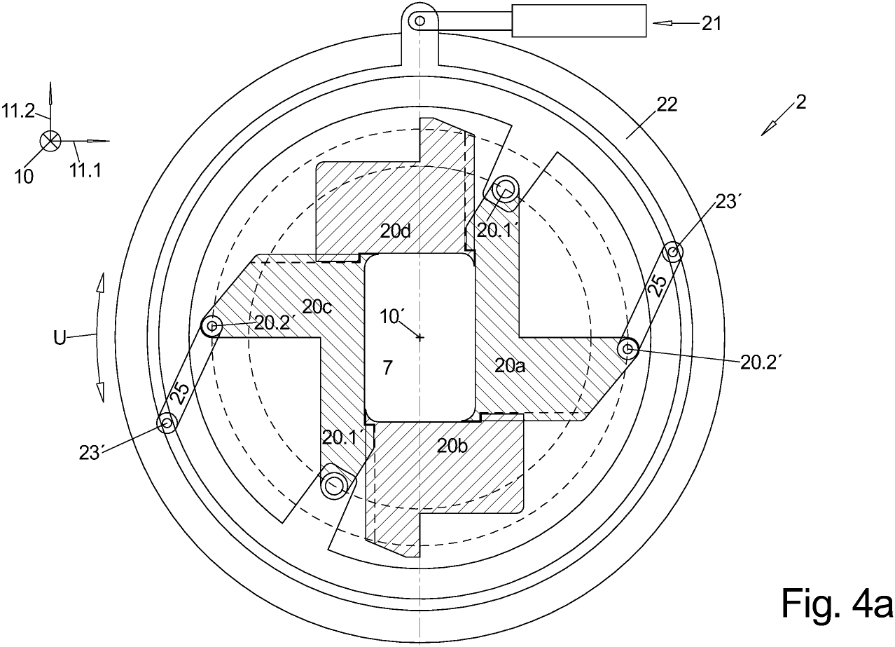

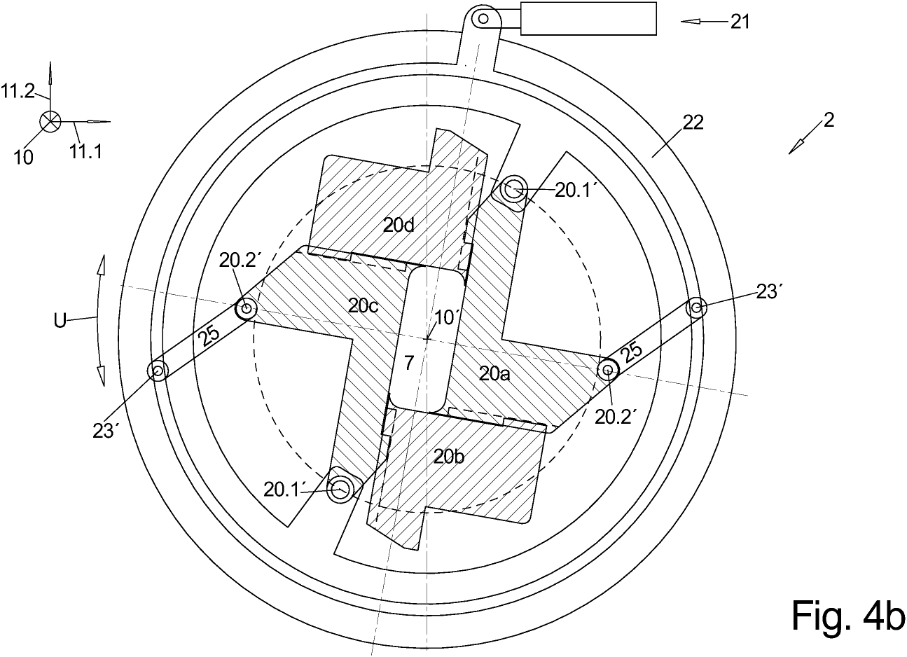

FIGS. 3a to 4b show the forming tube 20 according to the invention in each case viewed in the axial direction 10, that is to say from one end face open to the other, in each case four longitudinal walls 20a to 20d running in this axial direction, the longitudinal direction 10, which surround the forming cavity 7 circumferentially and which in each case have a preferably planar contact surface bounding the forming cavity 7, with which they later bear against the product piece 100 inserted into the forming cavity 7.

Accordingly, the forming cavity 7 has a rectangular cross-section, in this case with rounded corners due to a corresponding end edge region having an inner rounding, of the respective contact surface of each of the longitudinal walls 20a-d.

The contact surfaces – in the case of four longitudinal walls 20a-d – are thereby essentially at right angles to one another and are also held at this angle in that two adjacent longitudinal walls 20a, b, 20b, c, etc., are connected to one another via a wall guide 24 in such a way that, during relative movement of the adjacent longitudinal walls, e.g., 20b, 20c, with respect to one another, the intermediate angle between the contact surfaces is maintained, in this case remains at 90°. However, one of the two longitudinal walls, e.g., 20c, is displaced relative to the longitudinal wall 20d connected thereto in the direction of the longitudinal center line 10′ of the mold cavity.

The longitudinal centerline 10′ lies on the axis of symmetry of the forming cavity 7 in the case of point-symmetrical cross-sectional shapes of the mold cavity 7, and otherwise on the center of gravity of the cross section of the forming cavity 7.

In the case of a rectangle as shown here, the longitudinal centerline 10′ lies on the intersection of the two diagonals through the rectangular forming cavity 7.

In this case, the longitudinal guide 24 is preferably realized by an undercut groove 24a in one of the radially extending outer sides of the longitudinal wall adjacent to the adjacent longitudinal wall, and a groove block 24b formed on the adjacent longitudinal wall and movable along the undercut groove 24a. The groove opens into the radially outer side of the longitudinal wall, from where the groove block 24b can be inserted, but does not pass through to the contact surface of the longitudinal wall.

The forming tube 20 is concentrically surrounded by a base body 22 which is circular in shape in this embodiment and in practice is usually hollow cylindrical.

This base body 22, in particular base body ring, in this case has projections projecting radially inwards, and depending on the design, some or even all of the longitudinal walls 20a - d can be pivoted relative to the base body 22, in this case the corresponding projection of the base body ring 22, about a first pivoting axis 20.1′ running in the axial direction 10.

All of these longitudinal walls 20a - d, which are pivotably mounted directly relative to the base body 22, are hingedly connected to an actuating element 23 via a respective pivot lever 25. The actuating element 23 is here likewise annular in representation, in practice preferably cylindrical in design and arranged concentrically to the longitudinal center line 10′ of the forming cavity 7, preferably mounted rotatably about the longitudinal center line 10′ in the base body 22.

Each of the pivot levers 25 is thus articulated about a second pivot axis 20.2′ extending in the longitudinal direction 10 on one of the longitudinal walls 20a - d and is fastened at its other end about a base pivot axis 23′ to the actuating element 23 common to all pivot levers 25.

As indicated only in FIG. 3a, the actuating element 23 can be adjusted relative to the base body 22 in the circumferential direction U, for example controlled by a motor, by means of a control element 21, such as a working cylinder 21.

In the first embodiment according to FIGS. 3a, b, each of the longitudinal walls 20a - d is on the one hand hinged directly to the base body via a first pivot axis 20.1′ and on the other hand hinged to the actuating element 23 via a second pivot axis 20.2′ by means of a pivot lever 25.

If the actuating element 23 is pivoted clockwise by 5° relative to the base body 22 starting from the position of FIG. 3a, the mold cavity 7 is thereby reduced in size - as can be seen in FIG. 3b - but remains rectangular and, in particular, with the same ratio of length to width of its cross section. In addition, however, the cross section of the mold cavity 7 also rotates in this direction, e.g., clockwise by the same angle.

The individual longitudinal walls 20a - d move with their contact surfaces in a pivoting movement about the first pivot axes 20.1′ in the direction of the longitudinal center line 10′.

If this results in geometric overdeterminations, these can be eliminated by installing clearance in the form of elongated holes and bolts movable therein as pivot axes in two of the opposing longitudinal walls, but not in the other two longitudinal walls.

FIGS. 4a, b show a second embodiment of the forming tube 20 according to the invention, which differs from that in FIGS. 3a, b in that only in the circumferential direction U every second of the even number of longitudinal walls, i.e., in this case the two longitudinal walls e.g., 20a, 20c as described with respect to FIGS. 3a, b, are fastened to the base body 22 on the one hand and to the actuating element 23 on the other hand by means of first pivot axes 20.1′ and second pivot axes 20.2′ and pivot levers 25 fastened thereto.

Thus, by actuating the actuating element 23, only these two longitudinal walls 20a, c are actively displaced relative to the base body 22.

The other two longitudinal walls 20b, d are also automatically displaced by positive guidance, since they are movably connected to each of their two adjacent longitudinal walls 20a, c via a wall guide 24 in each case.

As a result, the angles between the contact surfaces of the individual longitudinal walls with respect to one another are maintained, even when the actuating element 23 is pivoted - as shown for 5° counterclockwise in FIG. 4b - and the cross section of the mold cavity 7 is also rotated as a result.

The advantage of the second design is that no geometrical overdeterminations can occur and, with non-self-locking formation of the longitudinal guides 24, a simpler design also results.

In both designs, a change in the size of the cross-section of the forming cavity 7 takes place centrally with respect to the longitudinal center line 10′, and in addition a rotation about the longitudinal center line 10′, in contrast to the known solution of FIGS. 2c, 2d, in which the bottom surface of the tubular forming tube channel 2.1 remains in position.

The advantage of the design according to the invention is the gentler pressing of the product piece 100 inserted in the mold cavity 7 due to the pressing forces acting centrally in the direction of the longitudinal center line 10′.

If the twisting of the forming cavity 7 and/or the change in position of all inner surfaces of the mold cavity 7, i.e., contact surfaces of all longitudinal walls 20a - d, is seen as a disadvantage, this can be compensated by a simple additional mechanism engaging the base body 22 and also actuated from the actuating element 23 - not shown, so that the circumferential surfaces of the forming cavity 7 retain their angular position relative to the X and Y directions in space even when the mold cavity 7 is changed and, if desired, at least one of the inner surfaces, i.e., a contact surface of one of the longitudinal walls, also retains its position when the size of the cross section of the forming cavity 7 is changed.

REFERENCE LIST

| | |
|---|---|
| 1 | slicing machine |
| 1* | control |
| 2 | forming tube unit |
| 2.1 | forming tube channel |
| 2 a | cutting end |
| 2 b | loading end |
| 3 | blade |
| 3′ | blade axis |
| 3″ | blade plane |
| 3 a | cutting edge |
| 4 | longitudinal press stamp |
| 5 | cross press stamp |
| 6 | cutting unit |
| 7 | internal free space, forming cavity |
| 7′ | inner free cross section |
| 8 | discharge conveyor |
| 9 | discharge conveyor |
| 10 | longitudinal direction, axial direction, feed direction |
| 11.1 | 1. transverse direction |
| 11.2 | 2. transverse direction |
| 12, 12′ | piston rod |
| 13 | stop plate |
| 14 | feed conveyor |
| 15 | base frame |
| 16.1 | scale |
| 16.2 | scale |
| 17 | distance |
| 18 | intermediate plate |
| 19 | support arm |
| 20 | forming tube |
| 20.1 | 1. pivot axis circle |
| 20.2 | 2. pivot axis circle |
| 20a - d | longitudinal wall |
| 20.1′ | 1. pivot axis |
| 21 | adjusting element, operating cylinder |
| 22 | base body |
| 23 | actuating element |
| 23′ | basic pivot axis |
| 24 | wall guide |
| 24a, b | guide parts |
| 25 | pivot lever |
| 99 | unpressed length |
| 99* | pressed length |
| 100 | unpressed product piece |
| 100* | pressed product caliber |
| 100″ | cross section |
| 100″ | max maximum cross section |
| 101 | slice |

1. A forming tube unit for forming an irregularly shaped product piece of an elastic material into a shape having a cross section uniform over its length, comprising:
a base body),
a forming tube having a forming cavity of variable cross section open from one end face to an opposite end face in a longitudinal direction, comprising:
longitudinal walls which adjoin one another in a circumferential direction and surround the forming cavity circumferentially,
the longitudinal walls being movable relative to one another in a transverse direction to the longitudinal direction of the forming tube, and
an actuating element for moving the longitudinal walls,
wherein all longitudinal walls are movably arranged with respect to the base body.

2. The forming tube unit according to claim 1, wherein
the base body, viewed in the longitudinal direction, is a base body ring surrounding the forming tube, and/or
the forming cavity is rotatable about a longitudinal center line during relative movement of the longitudinal walls with respect to one another.

3. The forming tube unit according to claim 1, wherein
the longitudinal walls comprise two longitudinal walls adjacent in the circumferential direction that are guidable against one another along a wall guide running in a transverse direction.

4. The forming tube unit according to claim 1, wherein
at least one of the longitudinal walls is attached to the base body so as to be pivotable about a first pivot axis extending in the longitudinal direction.

5. The forming tube unit according to claim 1,wherein
at least one of the longitudinal walls is pivotally attached to the base body so as to be pivotable about a first pivot axis extending in the longitudinal direction and is additionally pivotally attached to a pivot lever about a second pivot axis extending in the longitudinal direction and spaced from the first pivot axis,
each pivot lever is pivotably attached to the actuating element about a base pivot axis extending in the longitudinal direction, and
the actuating element is movable relative to the base body.

6. The forming tube unit according to claim 5, wherein each of the longitudinal walls is attached to the actuating element via a pivot lever that is pivotable about a second pivot axis, and at least one of the second pivot axes and/or the first pivot axis is movable transversely to the longitudinal direction .

7. The forming tube unit according to claim 1, further comprising multiple pivot levers that are each pivotably attached to the actuating element about a respective base pivot axis extending in the longitudinal direction, wherein
each of the longitudinal walls is pivotally attached to the base body about a respective first pivot axis extending in the longitudinal direction, and each of the longitudinal walls is additionally pivotally attached to a respective one of the pivot levers about a respective second pivot axis extending in the longitudinal direction and spaced from the respective first pivot axis, and
the actuating element is movable relative to the base body.

8. The forming tube unit according to claim 7, wherein
the first pivot axes are arranged on a first pivot axis circle when viewed axially and/or
the second pivot axes are arranged on a second pivot axis circle when viewed axially.

9. The forming tube unit according to claim 1, wherein
the actuating element comprises an actuating ring surrounding the forming tube, and
the actuating ring is rotatable about a longitudinal center line of the forming tube relative to the base body.

10. The forming tube unit according to claim 1, wherein
the actuating elementis operatively connected to a control element which can be driven in a controlled manner, and
the control element is movable in a transverse direction to the longitudinal direction, actuating to adjust the actuating element.

11. The forming tube unit according to claim 1, wherein
at least one of the longitudinal walls is guided so as to be movable linearly with respect to the base body in a transverse direction to the longitudinal direction; actuating.

12. The forming tube unit according to claim 11, wherein
each two adjacent longitudinal walls are guided against each other along a wall guide extending in a transverse direction.

13. A slicing machine for bringing an irregularly shaped product piece made of an elastic material into a shape with a cross section which is uniform over its length and then cutting it into slices, the slicing machine comprising:
the forming tube unit according to claim 1 for forming the product piece,
a cutting unit with, a rotating blade, and
a discharge unit with at least one discharge conveyor for conveying cut slices.

14. A method of forming an irregularly shaped, elongated product piece of a partially elastic material, the method comprising:
circumferentially enclosing the product piece in a forming cavity of a forming tube that extends in a longitudinal direction, wherein the forming cavity has a variable transverse cross-section uniform over its length, the forming tube comprises
longitudinal walls which are adjacent to one another in a circumferential direction and surround the forming cavity circumferentially, and
the longitudinal walls are movable relative to one another in a transverse direction transverse to the longitudinal direction, forming; and
displacing the longitudinal walls to form the product piece at least in one transverse direction that is transverse to the longitudinal direction, wherein
the displacing takes place in such a way that the longitudinal walls approach a longitudinal center line of the forming cavity linearly or by a pivoting movement, but do not lose mutual contact during the displacing.

15. The method according to claim 14, wherein
the displacing takes place in such a way that the cross section of the forming cavity is changed only quantitatively, not with regard to its shape.

16. The forming tube unit according to claim 2, wherein the base body ring comprises a base body circular ring that is configured to concentrically surround the forming tube.

17. The forming tube unit according to claim 3, wherein the wall guide comprises two guide parts that are guidable against one another and can be moved relative to one another only in a running direction of the wall guide but cannot be moved away from one another in a longitudinal region of the wall guide transversely to the wall guide.

18. The forming tube unit according to claim 17, wherein the two guide parts comprise an undercut guide groove and a sliding block displaceable therein.

19. The forming tube unit according to claim 4, wherein the longitudinal walls comprise an even number of longitudinal walls, and every second longitudinal wall is fastened to the base body so as to be pivotable about a first pivot axis running in the longitudinal direction.

20. The forming tube unit according to claim 7, wherein the forming tube unit comprises four first pivot axes that form a rectangle when viewed axially.
